(19) United States
(12) Patent Application Publication
(10) Pub. No.: US 2016/0239502 A1
(43) Pub. Date: Aug. 18, 2016

(54) Location-Activity Recommendations

(71) Applicant: Microsoft Technology Licensing, LLC., Redmond, WA (US)

(72) Inventors: Omar Alonso, Redwood Shores, CA (US); Stewart William Whiting, Hadleigh (GB)

(73) Assignee: Microsoft Technology Licensing, LLC., Redmond, WA (US)

(21) Appl. No.: 14/621,211

(22) Filed: Feb. 12, 2015

(51) Int. Cl. G06F 17/30

(52) U.S. Cl. CPC G06F 17/3087

(57) ABSTRACT

Systems, methods, and media bearing computer-executable instructions are provided for responding to a search query directed to a request for activities in a specified location. In response, a location-action data store storing a plurality of location-activity records is accessed and location-activity responses (each identifying an activity at a specific location) are returned. The location-activity records are aggregated from check-in data from a plurality of users from one or more social networking services.

### BACKGROUND

One of aspect of social networking services is that a substantial amount of data regarding user behavior is generated. While much of this data is likely considered to be personal or private information to those from whom it is generated, when appropriate restrictions and restraints are applied, the data represents a wealth of general information about people, their interests and behaviors.

One particular type of social networking data is “check-in” data. While aspects of the check-in data gathered by each individual social networking service may (and likely will) vary between differing services, at a fundamental level the check-in data gathered by each of the social networking services identifies the person to whom the check-in data corresponds, a “location” of the check in, and a date and time of the check in. In short, check-in data indicates that the particular persons/user indicated his/her presence at a particular location at a particular date and time.

Through analysis of check-in data (with appropriate anonymization techniques in place to ensure the privacy of each individual), a picture of behavioral patterns and interests of a population people can be generated.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems, methods, and media bearing computer-executable instructions are provided for responding to a search query directed to a request for activities in a specified location. In response, a location-action data store storing a plurality of location-activity records is accessed and location-activity responses (each identifying an activity at a specific location) are returned. The location-activity records are aggregated from check-in data from a plurality of users from one or more social networking services.

According to additional aspects of the disclosed subject matter, a computer system for responding to a search query regarding activities at an indication location is presented. The computer system comprises a processor and a memory, and further comprises a location-activity data store. The location-activity data store stores a plurality of location-activity records, where each location-activity record comprises information regarding a specific location and an associated activity in the specific location. Each record further comprising a number of check-in records indicating the number of check-ins at the specific location for the associated activity. The computer system further includes a query analysis component, a location-activity identification component, a location-activity results retrieval component, and a results page generator. The query analysis component is configured to analyze the search query to identify the elements of the query and the location-activity identification component is configured to determine whether the search query is a location-activity query that comprises a request regarding desired activities at a desired location. The location-activity results retrieval component obtains a set of location-activity results from the plurality of location-activity records in the location-activity data store that correspond to the desired activities at the desired location. Further, the results page generator is configured to generate a results page from the set of location-activity results for presentation to the computer user and return the results page to the computer user in response to the search query.

According to still further aspects of the disclosed subject matter, a method for responding to a search query from a computer user is presented. Initially, a location-activity data store is provided. The location-activity data store is provided with a plurality of location-activity records, each location-activity record comprising information regarding a specific location and an associated activity in the specific location. A search query is received, the search query being received from a computer user over a network. A determination is made as to whether the search query is a location-activity query identifying a desired activity at a desired location. Upon determining that the search query is a location-activity query, a set of location-activity responses from the location-activity records of the location-activity data store is identified, the set of location-activity responses being identified according to the desired location and the desired activity. A response page is generated from the set of location activity responses. The response page identifies a plurality of activities corresponding to the desired activity in the desired location, and the response page is returned for presentation to the computer user over the network.

According to additional aspects of the disclosed subject matter, a computer-readable medium is presented, the computer-readable medium bearing computer-executable instructions which, when executed on a computing system comprising at least a processor, carry out a method for responding to a search query from a computer user. In execution, the method comprises the following steps. Initially, a location-activity data store is provided. The location-activity data store is provided with a plurality of location-activity records, each location-activity record comprising information regarding a specific location and an associated activity in the specific location. A search query is received, the search query being received from a computer user over a network. The search query is then analyzed to identify elements of the search query. A determination is made as to whether the search query is a location-activity query identifying a desired activity at a desired location according to the identified elements of the search query. Upon determining that the search query is a location-activity query, a set of location-activity responses from the location-activity records of the location-activity data store is identified, the set of location-activity responses being identified according to the desired location and the desired activity. A response page is generated from the set of location activity responses. The response page identifies a plurality of activities corresponding to the desired activity in the desired location, and the response page is returned for presentation to the computer user over the network.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 illustrates a flow diagram of an exemplary routine for responding to a search query for temporal-location recommendations;

FIGS. 2A-2C are a pictorial diagram illustrating an exemplary presentation view showing response page generated in response to a location-activity query;

FIG. 3 is a flow diagram illustrating an exemplary routine 300 for providing a location-activity data store;

FIG. 4 is a block diagram illustrating an exemplary flow 400 of information from user into a location-activity data store;

FIG. 5 is a flow diagram illustrating an exemplary routine 500 for identifying location-activity responses/recommendations from a location-activity data store;

FIG. 6A is a pictorial diagram illustrating an exemplary presentation view showing response page generated in response to a location-activity query and further including user-actionable constraint controls for modifying the constraints associated with the location-activity query;

FIG. 6B is a pictorial diagram illustrating the exemplary presentation view showing a response page modified according to updated/modified purpose constraints;

FIG. 7 is a flow diagram illustrating an exemplary routine for responding to search query regarding a location-activity request, and further for responding to user-actionable constraint controls for updating constraints with regard to the location-activity request;

FIG. 8 is a flow diagram illustrating an exemplary routine for responding to a search query with search results and with location-activity search results;

FIG. 9 is a pictorial diagram illustrating an exemplary presentation window that includes search results view as might be retrieved if the query is not a location activity query;

FIG. 10 is a block diagram illustrating exemplary components of a suitably configured search engine 430 for responding to a location-activity query; and

FIG. 11 illustrates an exemplary network environment suitable for implementing aspects of the disclosed subject matter.

### DETAILED DESCRIPTION

For purposes of clarity, the term “exemplary,” as used in this document, should be interpreted as serving as an illustration or example of something, and it should not be interpreted as an ideal and/or a leading illustration of that thing.

By way of definition, the term “check-in record,” as used in this document, should be interpreted as a record/data indicating the presence of an entity (typically, but not exclusively, a person) at a particular location at a particular date and time. Additionally, the term “check-in data,” as used in this document, should be interpreted as a body of check-in records, typically corresponding to a plurality of entities, though there may be a plurality of check-in records for each or any one of the plurality of entities. With regard to “location,” it should be appreciated that this term refers to the particularly specified area as well as the surrounding region that is typically considered to within the specified area for conducting the requested activities. For example, the location “Seattle” means not only the city of Seattle but that region nearby that is considered to be within an activity area of Seattle. Thus, a response to a request for activities with regard to “Seattle” may include activities in surrounding communities (e.g., a concert in “Seattle” may actually occur Redmond or Tacoma). In addition to, or, as an alternative to inferring the specific location and surrounding areas consistent with what is considered as the general location, a person may also specify (either implicitly or explicitly) the particular region that should be considered for making recommendations. For example, a person may submit a location-activity query regarding activities (e.g., dining) within walking distance or within a half-hour drive of a hotel. Alternatively, a person may submit a location-activity regarding activities within a large region, such as what to do in San Juan, Puerto Rico. In this regard, while San Juan is a particular city with a particular surrounding area, it is also a vacation destination and, depending on a person's particular circumstances, activities may include exploring a rain forest, visiting a remote beach or resort, snorkeling in coral reefs, and the like, all of which might be viewed in some circumstances as activities falling outside the general San Juan area, but viewed as acceptable activities under other user considerations. Information such as available time, costs, transportation options, and types of activities may each play a factor in determining the particular region to consider when making recommendations to a location-activity query. Accordingly, while the following discussion will general refer location-activity queries with regard to a specific location and surrounding communities, this is for illustration purposes and should not be construed as limiting upon the disclosed subject matter.

Generally speaking, a check-in record is typically generated by a person via a computing device (such as a mobile computing device/phone) and transmitted to a corresponding social networking service. As will be readily appreciated, a social networking service corresponds to an online service/site that typically provides a mechanism for one or more persons/users to interact, such as sharing or posting information including activities, establishing social and/or familiar groups, and the like. Of course, one way in which people can share information is through check-in data. Thus, examples of social networking services through which check-in data is often gathered include, by way of illustration and not limitation, FourSquare® and Facebook®. However, other services that may or may not be viewed as traditional social networking services may also provide check-in data. These include services such as crowd sourcing services whose general purpose is to aggregate information from multiple participating people, to which these people submit information to the service (such as check-in data) for aggregation, and in which there may not be any interaction between participants. According to various embodiments of the disclosed subject matter, check-in data may also be obtained from these additional online services, and for purposes of this disclosure, the term “social networking service” should be viewed as including services from which check-in data regarding a plurality of persons/users may be obtained.

Regarding check-in records, check-in record may be generated automatically on behalf of the person/entity based on predetermined rules, heuristics, and detected events and/or locations, or by explicit instructions of the person to do so. As indicated, an entity typically corresponds to a person but an entity may also correspond to a group of people, an organization, a particular item, and the like. Also, the location to which the person/entity checks in may be a physical location or, in some instances, a virtual event or location such as an online meeting, a virtual conference, an online game instance, and the like.

A location-activity record corresponds to a record in the location-activity data store that represents a particular activity for a specific location/area. As a minimum, the location-activity record includes information regarding the activity and the location. Additionally, the location-activity record may include information regarding the number of check-ins that correspond to the particular record, user feedback (including feedback obtained from other services, including recommendation services), directions to the activity, related information regarding the activity, and the like.

When a person is interested in learning about activities (i.e., what to do) in a certain location, often that person will generate a search query and submit that query to a search engine, such as Bing® or Google®. As should be appreciated, the requested activities may be in regard to recreational activities (which may involve others than just the person requesting the information), dining information, leisure/relaxation activities, fitness and exercise opportunities, cultural discovery and/or enrichment activities of the area, and the like. In response to the search query (about what to do in the area), the person will typically receive one or more web pages of search results that are selected according to their relevance to the search query. As will be readily appreciated, the search results typically comprise hyperlinks to web pages hosting the content that is considered relevant (and therefore responsive to) the search query.

By way of example, a person may wish to know (and generate a search query for), “what are things to do in Seattle?” The search engine, upon receiving this search query, searches its content index for web pages that describe activities (“things to do”) in and around Seattle. Of course, the search engine will likely have references to many web pages that are relevant to any given search query, including those relevant to activities in any given area. Thus, in addition to simply identifying the web pages that have at least some relevant information to the query, the search engine scores the various relevant web pages in view of the intent of the query. The search results are scored in order to provide the requesting person a list of what it determined to be the “best” results for the query. In scoring the results, the search engine may consider various items of information about the requesting person, as well as considering what a large body of people that submit that same(or similar query) would view as being the best results. With the relevant results (references to web pages) identified and scored, the search engine generates one or more pages of results with the most highly scored results at the top, i.e., those results viewed as more relevant are displayed among the first results presented to the requesting person. From this point, of course, the person must select/follow one or more hyperlinks to the web pages of others to view the content of the web page that the search engine considered to be relevant, i.e., discover what to do in a particular location.

As can be seen above, in the current paradigm of submitting search queries to a search engine, a person submits a query and receives a list of web pages that, presumably, answer the query. Unfortunately, the results of the search query involve at least one level of indirection: rather than directly answering the query with the requested information collected and presented to the person, the search engine responds with information (search results/hyperlinks) for locating the requested information. Of course, while there may be instances where obtaining a list of references to web pages that likely contain the sought-for information is desirable, more often the indirection (via hyperlinks) is a cause of frustration and inefficiency.

One of the reasons that search engines respond with search results/hyperlinks rather than responding with the requested information is found in the way that the search engines operate: rather than copying or duplicating the content of the numerous web pages on the Internet, a search engine will evaluate the contents of a web page, extract (or generate) key terms and elements of the web pages, and add the extracted information regarding that web page to a massive content index which associates the web page with the extracted key terms and elements. The search engine will employ crawling processes that scan the web pages of the Internet: constantly identifying and indexing the content of previously unknown web pages, as well as updating any known web pages that have been modified. As should be appreciated, crawling and indexing involves massive amounts of computing resources and time to accomplish.

As mentioned above, the results that are returned from a search query are scored. The scoring is based on certain preferences that may be associated with the requesting person, as well as how others, many others, have interacted in some form with the various web pages that are referenced by the content index. Indeed, search engines obtain as much information as possible regarding a person's behaviors in order to infer, with statistical significance, what might be the best web sites for a given search query. As with crawling and maintaining a context index, correlating the behaviors of many people (certainly millions and perhaps billions of people) with regard to determining which web sites are the “best” for given search query takes a lot of resources and a lot of time to develop. Thus, when a person asks/queries, “what is there to do in Seattle?” a search engine may not consider relatively new options as it takes time and resources to identify a web page as including the best information.

Generally, search engines rely upon web content that can be accessed and indexed, a process that can a substantial amount of time given that there are billions of web pages. This tends to make the data that a search engine provides less immediate. To compensate and consider more recent content in search results, some search engines establish special indices of recent content which are ultimately transitioned to the established content index. Even so, it is always a challenge for a search engine provide search results to the “freshest” content—that content which is most recent. Moreover, while a search engine may be challenged to keep up very recent trends as to what is popular to do in a given location, the a search engine still responds indirectly in the form of search results, references to other web sites that have information relevant to the query. On the other hand, it is very likely that individuals in a particular area are aware of what is going on, they likely have preferences as to what to do there for any given activity, they often make a record (i.e., a check-in record) of what they do, and the check-in data can be readily and immediately available and the popularity of “what to do” can be inferred or determined based on the number of check-ins at a particular event. According to aspects of the disclosed subject matter, direct answers to search queries that request information regarding an activity for a particular location is quickly and efficiently derived from the check-in data of a plurality of users obtained from one or more social networking services. According to various embodiments of the disclosed subject matter, these direct answers may be provided in response to a search query alone and/or in combination with the typical search results.

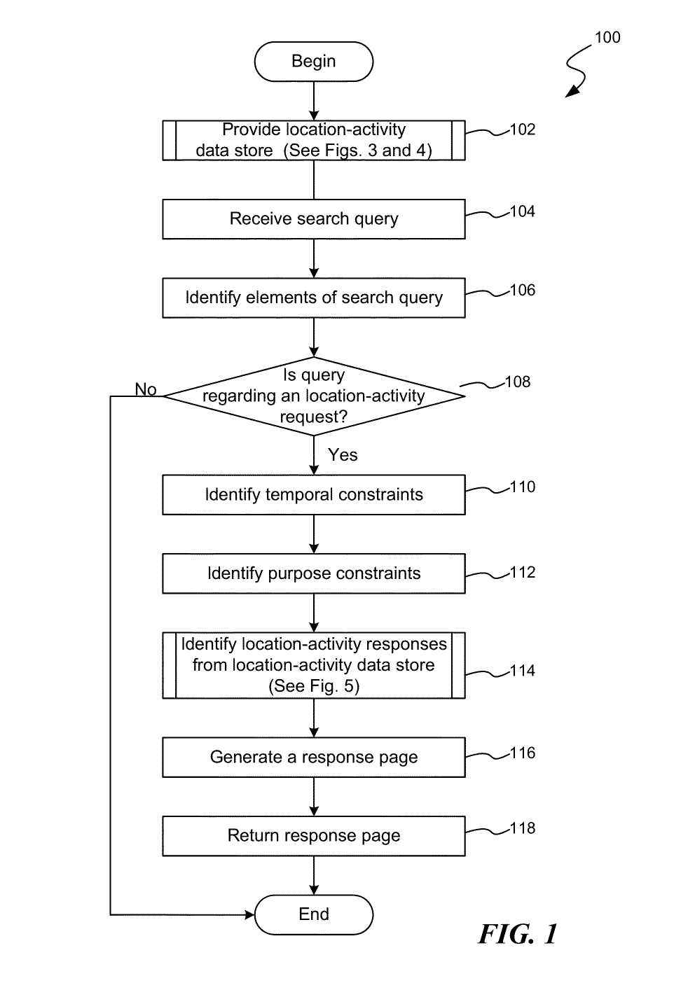

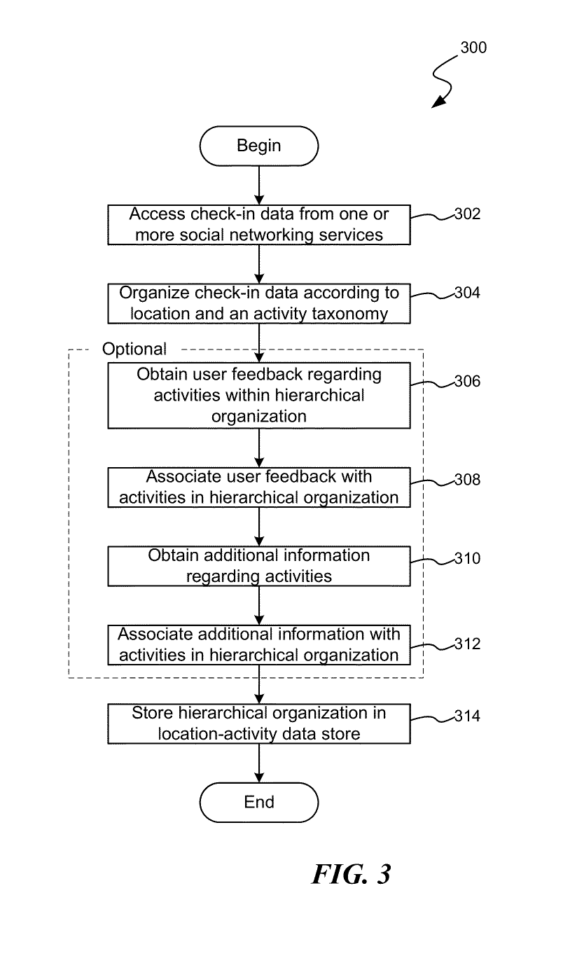

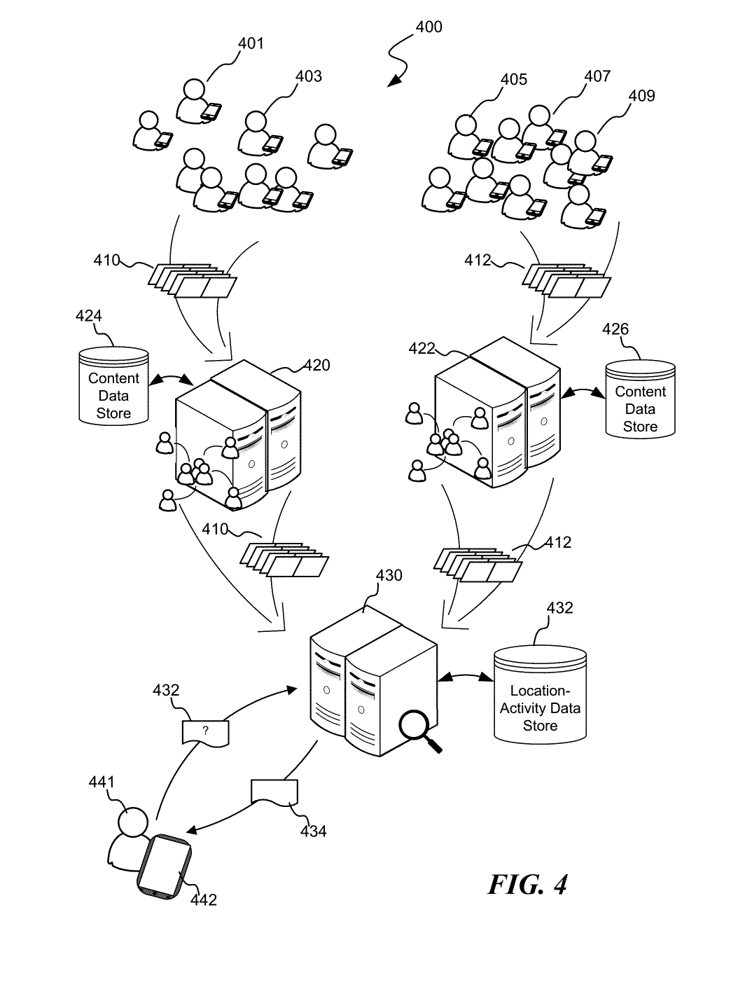

Turning now to the figures, FIG. 1 illustrates a flow diagram of an exemplary routine 100 for responding to a search query for temporal-location recommendations. Beginning at block 102, a location-activity data store storing location-activity content derived from check-in data of a plurality of entities is provided. The provision of the location-activity data store is described in greater detail below in regard to FIGS. 3 and 4.

At block 104, a search query is received. At block 106, an analysis of the search query is performed to identify the various elements of the search query, such as an indication as to a specific location, an indication regarding a desired activity, and the like. The analysis may be made according to lexical and/or semantic analyses of the search query based on pattern matching and the like to identify the various structure elements.

At decision block 108, a determination is made based on an analysis of the search query as to whether or not the search query is directed to a location-activity request. According to aspects of the disclosed subject matter, a location-activity request corresponds to a request made with regard to a particular location and a desired activity at that location. In regard to the example set forth above, “what to do in Seattle?”, the activity portion is “what to do” and the location portion is “Seattle.” Typically, both elements (location and activity) are identified in the search query in order for the query to be identified as a location-activity request. Of course, in some embodiments, a location may be implied according to the particular location of the person making the request (such as a location determined by the IP address of the person making the request, or a location determined from the GPS location of the person's mobile device, and the like.) In this instance, a search query of “what to do” could imply the present location of the user and view the query as a location-activity request.

In regard to the activity portion, as the name suggests this portion is characterized, in general, as an activity, i.e., what to do. While the examples of activity portions may be very generic with regards to an activity, i.e., “what to do,” the query need not be formed in this particular manner. An activity or action may be implied by the nature of the question being asked. For example, queries described in terms of “where to eat” or “how to spend an evening” each implicate an activity. When a search query includes a request for an activity, and combined with particular location, the determination at decision block 106 would find that the query is, in fact, a location-activity query.

According to aspects of the disclosed subject matter, in order to determine whether or not a search query includes at least an activity request of a location, a semantic analysis of the query is made to identify various structural elements of the query. Pattern matching, parts of speech identification, and entity resolution/identification may be used to identify elements of the search query, including the activity portion and the location portion. As mentioned above, this query analysis is conducted for determining whether or not the search query is a location-activity query that may be answered by location-activity responses, as disclosed herein.

As illustrated in routine 100, if the determination is made that the query is not a location-activity query, the routine 100 terminates. Of course, this does not mean that the search engine cannot reply to the search query. According to various embodiments of the disclosed subject matter, if the query is not a location-activity query, the search engine response in the manner described above: providing search results referencing one or more web pages containing information viewed as being relevant to the query.

After determining that the query is a location-activity query, at block 110, in addition to identifying by the location portion and the activity portion of a search query, an examination of the elements of the query is also made to identify any temporal constraints with regard to the location-activity request. According to aspects of the disclosed subject matter, these temporal constraints may include temporal indicators such as, by way of illustration and not limitation: this evening; tonight; tomorrow; now; this week; this weekend; a particular season or holiday; a specific date/time; and the like. Unlike the activity portion of the search query, temporal constraints are optional elements that may be used to clarify the person's intent with regard to the location-activity request.

In addition to identifying temporal constraints (if any are present), at block 112 an examination of the elements of the query is also made with regard to identifying any purpose constraints that may be provided. Purpose constraints are derived from terms and phrases in the search query that identify a type of intent or motivation (i.e., a purpose) for which the location-activity request is made, beyond just “what to do.” For example, a query such as “where to go to eat dinner in Seattle,” the intent of the activity (i.e., where to go) is “to eat dinner.” While temporal constraints identify some aspect of time for conducting an activity, purpose constraints tend to be more nuanced and varied. Purpose constrains may be included to identify a motivation or theme behind an activity, e.g., “a romantic evening,” or to modify or clarify the nature/purpose of activity, e.g., “to eat dinner.” Examples of purpose constraints include, by way of illustration and not limitation: inexpensive; free; to eat dinner; for sushi (or any type of food and/or cuisine); a romantic activity; for entertainment; kid friendly; for sightseeing; for walking; fitness related; and the like.

While a typical location-activity request will often include only one temporal constraint (unless joined by Boolean operators such as AND and OR), a location-activity request may include/identify zero or more purpose constraints. For example, the search query “what to do in Seattle with kids for free” includes no temporal constraints but includes two purpose constraints: “with kids” and “for free.” On the other hand, the search query “what to do in Seattle with kids on weekends and mornings” includes one purpose constraint, “with kids,” and illustrates that plural temporal constraints, “weekends” and “mornings,” may be combined through the use of Boolean operators.

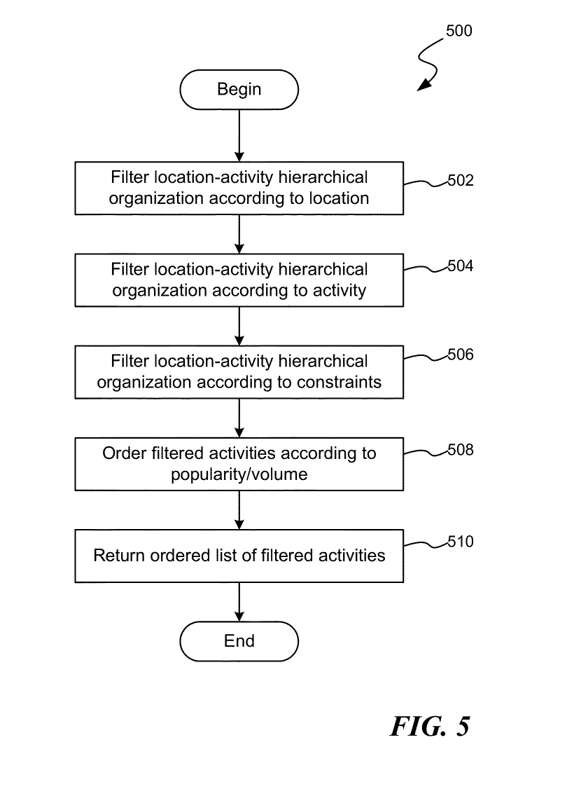

After capturing the temporal and purpose constraints (if are any present in the location-activity query), at block 114 one or more location-activity responses are identified from a location-activity data store maintained by or accessible to the search engine. Identifying location-activity responses from a location-activity data store is described below in regard to FIG. 5. At block 116, at least one set of responses (referred to as a response page) is generated to present the location-activity responses to the person that submitted the query, and at block 118 the response page is returned to the person that submitted the location-activity query for presentation to the person on presentation device, such as computer's display screen. Thereafter, the routine 100 terminates.

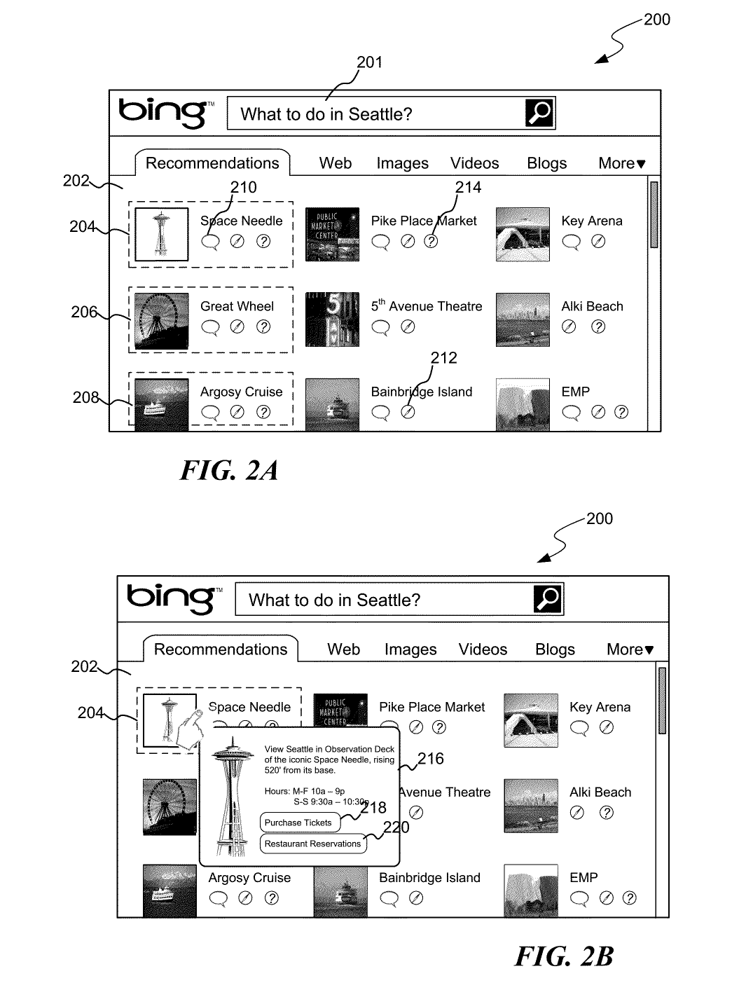

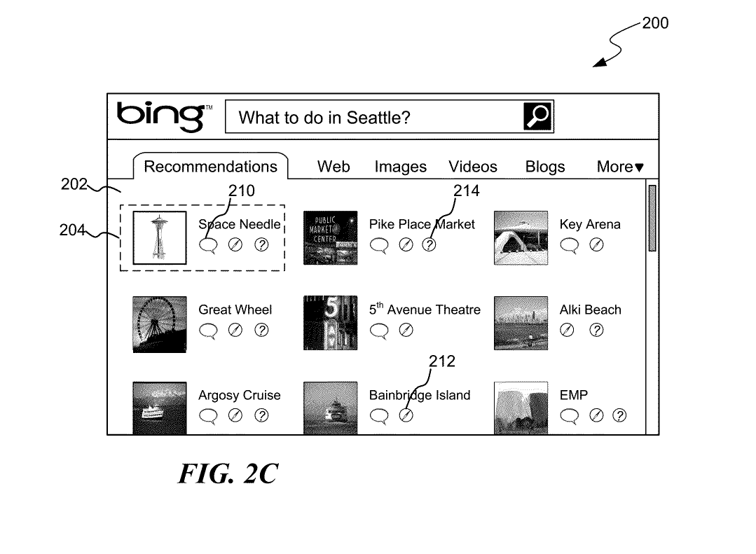

FIGS. 2A-2C are a pictorial diagram illustrating an exemplary presentation view 200 showing response page 202 generated in response to a location-activity query 201, “What to do in Seattle?” As can be seen in FIG. 2A, in the exemplary response page 202 there are a number of responses (i.e., location-related activities), including location-activity responses 204-208. As described above in regard to routine 100 of FIG. 1, these responses were identified as being relevant and responsive to the location-activity query 201. Advantageously, rather that referencing web pages that describe what can be done in Seattle, according to aspects of the disclosed subject matter a list of recommendations of what to do in Seattle are presented. Further still and according to additional aspects of the disclosed subject matter, the location-activity responses were selected according to the number/volume of check-ins an the various locations, thereby inferring a level of popularity.

In FIG. 2B, the exemplary presentation view 200 illustrates how a user might interact with a location-activity response, such as location-activity response 204. In one embodiment, upon a user interacting with a location-activity response a pop-up view, such as pop-up view 216, is presented with information corresponding to the particular activity. The displayed information of the pop-up view 216 may be derived from one or more sources (including an official source of the activity), and further include interactive controls, such as interactive controls 218 and 220, related to the activity. For example, in pop-up view 216, interactive controls 218 and 220 enable the person to purchase tickets to ride up in the Space Needle, as well as enable the person to make dining reservations at the location. Of course, in an alternative embodiment, interacting with a location-activity response, such as location-activity response 206, may operate as a hyperlink to a particular web site relating to the activity, such as an office site for the corresponding activity.

Turning to FIG. 2C, the location-activity response may also be annotated with user-actionable controls for displaying additional information regarding the activity. For example, location-activity response 204 is annotated with a user feedback control 210 that displays user feedback/comments regarding the particular activity. According to aspects of the disclosed subject matter, a user feedback control, such as user feedback control 210, may be configured to display user feedback in view of the particular temporal and/or purpose constraints included in the location-activity query. For example, for a broad query such as “what to do in Seattle,” the user feedback control 210 may provide information (such as in a pop-up window) of a general nature. In contrast, if the query were for “what romantic thing to do in Seattle,” the user feedback controls may be configured to provide user feedback in regard to the activity and in further regard to the particular purpose (romantic) indicated in the query. In other words, the interaction controls, such as user feedback control 210, are context sensitive in regard to the particular constraints, both temporal and purpose constraints, which are selected/indicated with the activity request.

Additional user-actionable controls may be provided for any one of the location-activity response, including a “more information” control 214 that provides additional information (i.e., prices, hours, availability, formal attire required, recommendations to make reservations, upcoming events, special offers and/or coupons, menu and menu information, information regarding the staff, published reviews, and the like) regarding the corresponding activity. A direction control 212 may also be associated with any one or all of the location-activity responses providing guidance/direction to the particular activity.

It should be appreciated that while displaying results in response to a query, even location-activity responses such as presented in FIGS. 2A-2C, may superficially appear as simply displaying search results in a different arrangement, in fact the disclosed subject matter is substantially distinct. As suggested above, rather than presenting search results—each directed to an external web site on the Internet that hosts information relevant to the query, the location-activity responses represent the sought-for information (i.e., activities in and around the specified location.) The requesting user is not forced to navigate away from the displayed results to another web page to view what that web page suggests or discloses. Further, the location-activity responses, such as location-activity responses 204-208, are obtained from a location-activity data store derived from the check-in data of multiple persons in the particular location of the requested activity. In other words, the location-activity responses represent recently activities performed by others according to the check-in data of the others. The location-activity responses, including location-activity response 204-208, may be ordered according to popularity, with the most popular activities being displayed first, as determined by the amount of check-ins that occur at a particular venue. Thus, the presentation of results is based on the number of people (as indicated by check-in records) that were present at a particular activity/location, rather than the popularity of a web site.

In regard to providing a location-activity data store (as mentioned above in regard to block 102 of FIG. 1, reference is now made to FIGS. 3 and 4. FIG. 3 is a flow diagram illustrating an exemplary routine 300 for providing a location-activity data store, and FIG. 4 is a block diagram illustrating the exemplary flow 400 of check-in information from user into a location-activity data store. As shown in FIG. 4, a plurality of people, such as persons 401-409, generate check-in data 410 412 as they indicate their presence (either automatically or at explicit direction) at one or more venues/events. As shown, the check-in data 410 412 is provided to and aggregated by a social networking service, such as one of social networking services 420 and 422. The check-in data at each social networking service is stored in a content data store, such as content data stores 424 and 426.

A search engine (or other service provider configured to respond to search queries), such as search engine 430, accesses the check-in data 410 412 from the one or more social networking services 420 422, as indicated in block 302. As indicated by block 304, the search engine organizes the check-in data according to location and further according to an activity taxonomy. According to at least one embodiment, the activity taxonomy defines a hierarchical arrangement of activities that may be found in any particular location. The activity taxonomy further provides for the inclusion of indications of temporal and purpose constraints with regard to any particular activity. More than one temporal and/or purpose constraint may be associated with each activity within a hierarchical organization of check-in data, organized according to the activity taxonomy.

As suggested, from block 304 the effect of organizing the check-in data according to an activity taxonomy is a hierarchical arrangement of activities (based on check-in data as well as based on query logs and browsing histories) with any temporal and/or purpose constraints associated with any given activity, as determined from the check-in data. Regarding the activity taxonomy, as indicated above, the taxonomy is generated according to check-in information in light of information derived from query logs and browsing histories. While query logs and browsing histories do not indicate the presence of a person (i.e., a check in record) at a location, they do provide useful information upon which aspects/constraints may be determined. For example, from the query logs and browsing histories—in combination with check-in data—a search engine 430 may be able to make recommendations as to what to do with kids in Seattle, or where to go for a relaxing walk with views. Data mining the query logs and browsing histories provides, in combination with the check-in data, provides the basis of generating an activity taxonomy. The hierarchical organization comprises location-activity records including a location, an activity, number of check-ins for a particular constraint, and the like. In organizing the check-in data according to the activity taxonomy, the volume of check-in data with regard to the temporal and/or purpose constraints is also maintained, such that those activities having higher volume are considered to be more popular and more likely to be a desirable activity, including for any particular temporal and/or purpose constraint or a combination of them both.

The steps of blocks 306-310 are viewed as optional, but provide additional meaningful information to the location-activity data in the hierarchical organization. At block 306, the search engine 430 obtains user feedback information regarding the activities within the hierarchical organization. As with the volume of check-in data, user feedback data may be differentiated according to any temporal and/or purpose constraints. For example, user feedback with regard to the Ferris wheel in Seattle, referred to as “The Great Wheel,” may vary widely depending on the temporal and/or purpose constraints associated with the activity. As a romantic activity, user feedback may include comments to the effect that an evening ride on the Great Wheel is a great romantic activity, where other user feedback may indicate that an evening ride on the Great Wheel is a scary activity for younger kids. For efficiency, the search engine 430 may filter the user feedback it obtains with regard to the various activities such that only those items of user feedback that are viewed as the most informative for any given activity with regard to both temporal and purpose constraints (where appropriate) is retained. Thus, at block 308, the user feedback is associated with the corresponding activities within the hierarchical organization.

At block 310, additional information (as presented by the more information controls associated with location-activity responses) regarding the activities in the hierarchical organization is also obtained and, in block 312 this additional information is associated with the corresponding activities. This addition information may correspond to (by way of illustration and not limitation) price information, parking, hours of operation, seasonal schedules, that reservations are recommended and/or required, required attire, age limits, and the like.

Once the hierarchical organization of location activities is arranged as described above, as indicated in block 314, the hierarchical organization is then stored in the location-activity data store in a manner that is both efficient and readily accessed by the search engine 430. Thereafter, the routine 300 terminates. As illustrated in FIG. 4, with a location-activity data store provided, a person 441 may submit a location-activity query 432 to the search engine 430, which processes the query as described below in regard to FIG. 5, and returns one or more response pages, such as response page 434 to the person for display on a computing device 442.

In regard to identifying location-activity responses from a location-activity data store (as indicated above in regard to block 112 of FIG. 1), FIG. 5 is a flow diagram illustrating an exemplary routine 500 for identifying location-activity responses/recommendations from a location-activity data store. Beginning at block 502, the hierarchical location-activity organization is filtered according to the location of the location-activity query (as described above in regard to routine 100 of FIG. 1.) At block 504, the hierarchical location-activity organization, filtered by location, is further filtered according to the desired activity identified from the location-activity query. The activities include all activities (both general and more specific) that satisfy the query. At block 506, the hierarchical location-activity organization, filtered by location and activity, is further filtered according to any constraints identified in the location-activity query, including both temporal and purpose constraints. The results of this filtering is a subset of the hierarchical location-activity organization that includes only those activities that satisfy the location-activity query.

At block 508, the remaining activities in the subset of the hierarchical location-activity organization are ordered according to various criteria, one of which (though not necessarily the only criterion) is the popularity of a given activity (based on volume of check-ins of this activity with regard to the specified temporal and purpose constraints). In block 510, this ordered list of results (activities for the particular location and according to any specified temporal and purpose constraints) is returned. Thereafter, the routine 500 terminates.

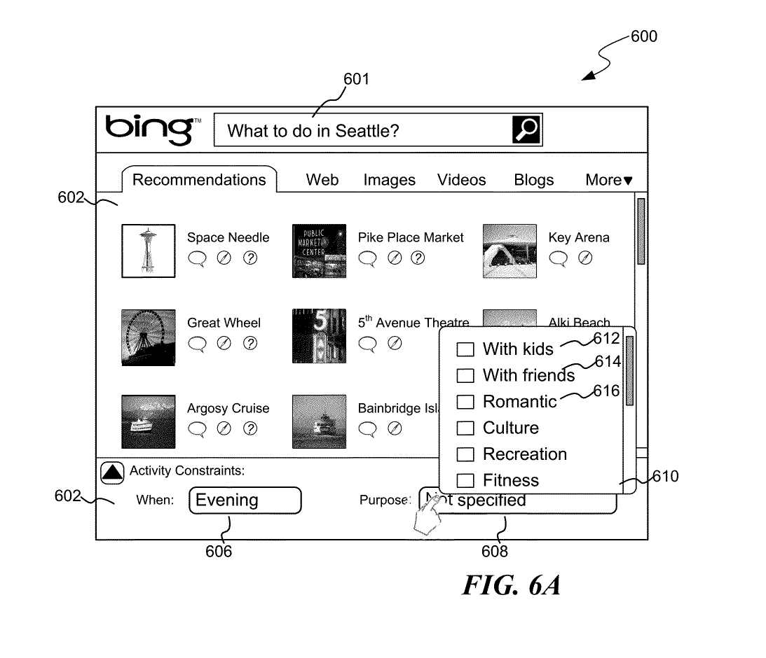

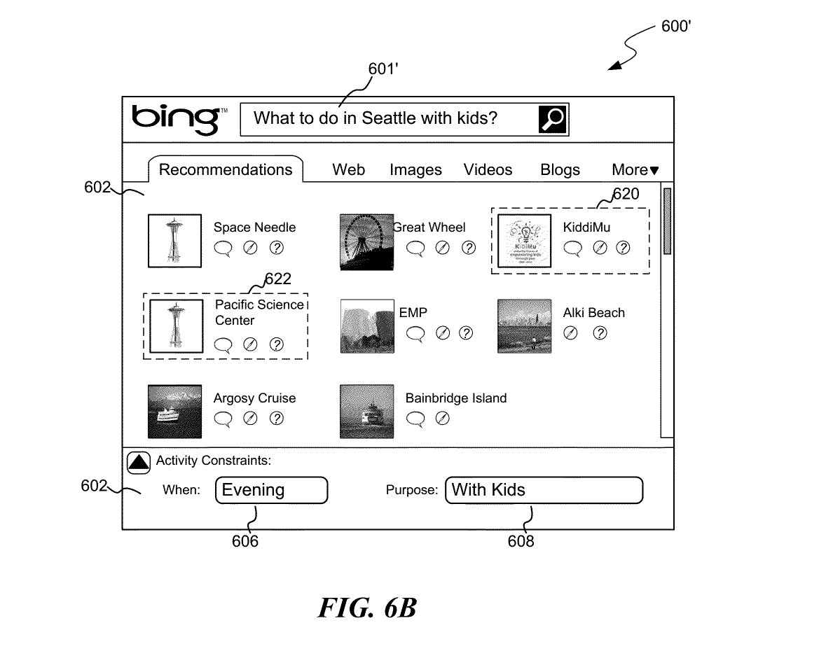

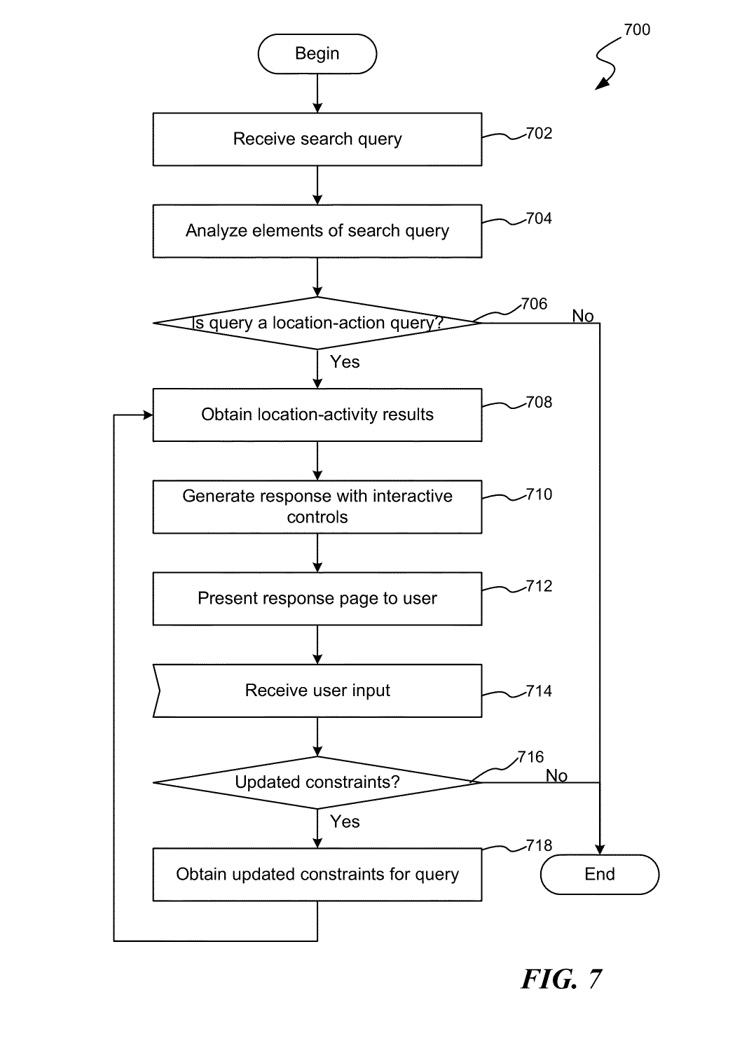

In addition to providing a response page including multiple location-activity responses generated in response to a location-activity query, a search engine 430 may also include controls by which the person may modify the constraints, both temporal and purpose, of the query. FIG. 6A is a pictorial diagram illustrating an exemplary presentation view 600 showing response page 602 generated in response to a location-activity query 601, “What to do in Seattle,” and further including user-actionable constraint controls for modifying the constraints associated with the location-activity query. FIG. 6B is a pictorial diagram illustrating the exemplary presentation view 600’ showing a response page modified according to purpose constraints. FIG. 7 is a flow diagram illustrating an exemplary routine 700 for responding to search query regarding a location-activity request, and further for responding to interactive controls for updating constraints with regard to the location-activity request.

As described above in regard to FIG. 1, beginning with block 702, a search query is received. At block 704, an analysis of the search query is conducted in order to identify various elements of the query. At decision block 706, a determination is made as to whether the query is a location-activity query, i.e., is directed to a query regarding a specified location and a requested activity (as well as optionally including temporal and/or purpose constraints.) If no, for purposes of the description of routine 700, the routine terminates. Alternative, if the query is a location-activity query, the routine proceeds forward to block 708.

At block 708 (and as described above in regard to FIG. 1), location-activity results are obtained from the aggregated check-in data in the hierarchical organization. At block 710, a response page is generated with regard to the location-activity results obtained in block 708. At block 712, the generated response page is presented to the user.

In addition to the description above in regard to routine 100 of FIG. 1, the response page includes user-actionable controls for updating/modifying the constraints with regard to the location-activity request. As shown in FIG. 6, the presentation view 600 includes a response page 602 that includes a panel 604 for presenting user-actionable controls 606 and 608 which can be manipulated by the person submitting the query to modify or update any constraints associated with the query. For example, user-actionable control 606 enables the person to modify temporal constraints associated with the query 601, “What to do in Seattle?” Similarly, control 608 enables the person to modify the purpose (or purposes) of the location-activity query. As shown in FIG. 6, upon interacting with user-actionable control 608, a pop-up window 610 is presented that includes additional user-actionable controls, such as user-actionable controls 612-616, by which the purpose constraints can be modified. Of course, the particular displayed user-actionable controls are merely exemplary of the types and arrangement of controls for modifying the various constraints of the location-activity query, and should be viewed as illustrative and not limiting upon the disclosed subject matter.

Returning to FIG. 7, at block 714, user input is received in regard to modifications to the constraints. At decision block 716, if the user input indicates that the user is making no modifications to the location-activity query constraints, the routine terminates. Alternatively, at block 718 the updated/modified constraints regarding the location-activity query are obtained and the routine 700 returns to block 708 where location-activity responses to the query 601 (as modified by the updated constraints) are obtained.

The routine 700 continues as described above until there are no more updates to the constraints from the user (as determined in decision block 716), where upon the routine 700 terminates.

By way of illustration in regard to updating the constraints regarding a location-activity query, reference is made to FIG. 6B. As shown in FIG. 6B, the updated presentation view 601 is a pictorial diagram illustrating the exemplary presentation view 600′ includes the response page 602 but includes a different arrangement of location-activity responses, including location-activity responses 620 and 622 which were not displayed in the response page 600 of FIG. 6A. Of course, this reflects the selection of response activities according to the query 601′ (which is shown as being updated according to the addition of the purpose constraint “with kids”) and the constraints that are applied.

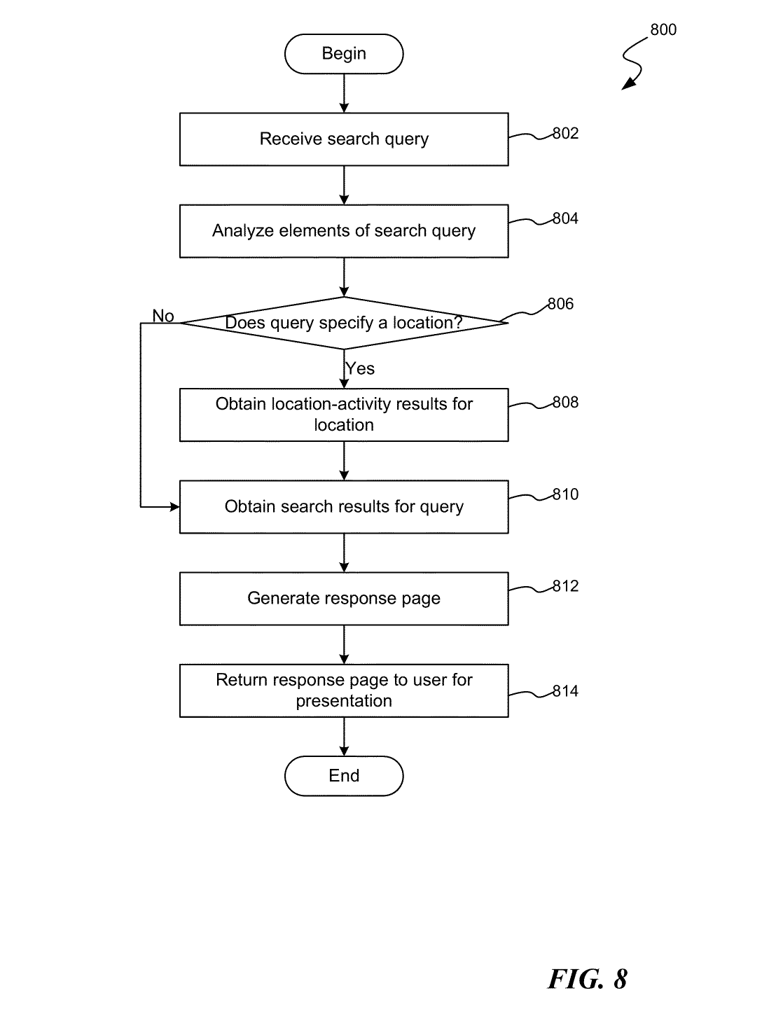

Often, it may be difficult infer that a person is requesting information of a location-activity request. For example, the query “top venues in Seattle” may imply that the person is requesting information about what to do in Seattle, but perhaps not. In any event, in various embodiments of the disclosed subject matter, rather than only retrieving location-activity results in response to a query that can be specifically identified as a location-activity query, location-activity responses can be obtained with regard to any search query upon detecting a particular location within the query. To that point, FIG. 8 is a flow diagram illustrating an exemplary routine 800 for responding to a search query with search results and with location-activity search results. Beginning at block 802, the search engine 430 receives a search query from a requesting person/user. At block 804, an analysis of the search query is conducted to identify the various elements of the search query. Assuming (for the purposes of this routine 800) that the search query does not qualify as a location-activity search query, at decision block 806 a determination is made as to whether the query includes/specifies a location. If not, the routine 800 proceeds to block 810 for continued processing. However, if the query includes a particular location, at block 808 a set of location-activity response is obtained for the specified location. At block 810, search results (as described above in regard to typical search query processing) are obtained. At block 812, a search results response page is generated to include (if obtained) the set of location-activity responses. Thereafter, at block 814, the response page is returned to the requesting person and the routine terminates.

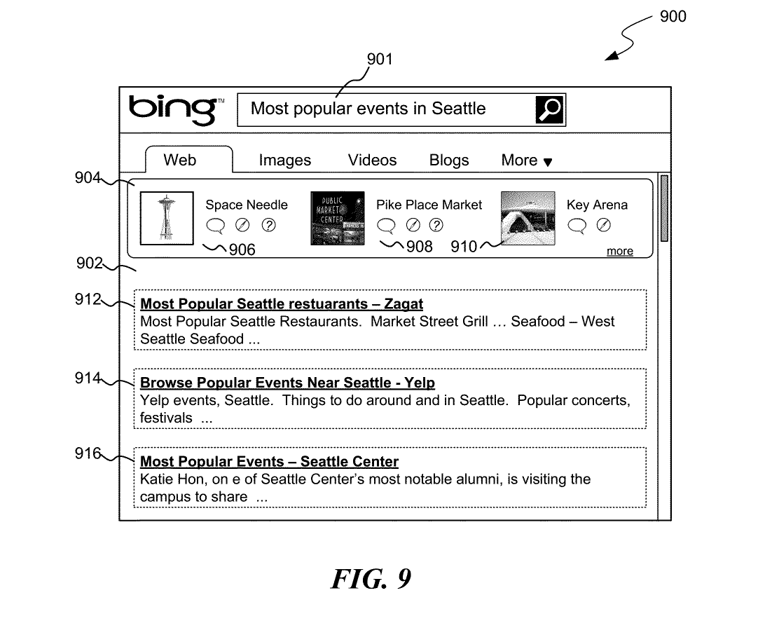

FIG. 9 is a pictorial diagram illustrating an exemplary presentation window 900 that includes search results view 902 as might be retrieved if the query 901 is not a location activity query, and a location-activity results panel 904 that includes location-activity responses 906-910 since the query includes a specified location. As shown in FIG. 9, in addition to the typical search results 912-914 that may be provided in response to a search query, the presentation window 900 includes location-activity results 906-910 in the location-activity results panel 904. Of course, while this particular figure is illustrative of the presentation of both “typical” search results with location-action results, it should also be appreciated that in an actual embodiment the particular view (with both typical search results and location-action results) may be configured in any number of ways.

In yet a further alternative, rather that displaying location-action results with the search results page (such as shown in FIG. 9), various constraints may be added, typically determined according to information particular to the requesting person, that are considered of value. For example, in response to the query “most popular places in Seattle”, a “bundle” of search results may be generated with the purpose constraint of “to eat,” while a bundle of search results may be generated with regard to a temporal constraint “this evening,” and so on.

Regarding routines 100, 300, 500, 700 and 800 described above, as well as other processes describe herein, while these routines/processes are expressed in regard to discrete steps, these steps should be viewed as being logical in nature and may or may not correspond to any actual and/or discrete steps of a particular implementation. Also, the order in which these steps are presented in the various routines and processes should not be construed as the only order in which the steps may be carried out. In some instances, some of these steps may be omitted. Those skilled in the art will recognize that the logical presentation of steps is sufficiently instructive to carry out aspects of the claimed subject matter irrespective of any particular language in which the logical instructions/steps are embodied.

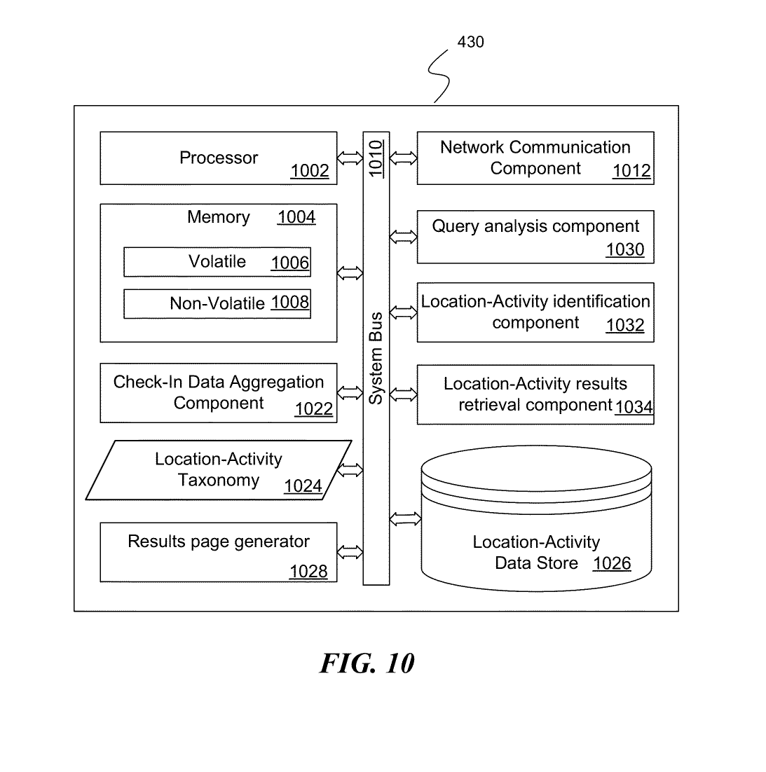

Of course, while these routines include various novel features of the disclosed subject matter, other steps (not listed) may also be carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 10 below. Additionally, in various embodiments all or some of the various routines may also be embodied in executable hardware modules including, but not limited to, system on chips, specially designed processors and or logic circuits, and the like on a computer system.

These routines/processes are typically embodied within executable code modules comprising routines, functions, looping structures, selectors such as if-then and if-then-else statements, assignments, arithmetic computations, and the like. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed, applications), and/or methods, these aspects may also be embodied as computer-executable instructions stored by computer-readable media, also referred to as computer-readable storage media, which are articles of manufacture. As those skilled in the art will recognize, computer-readable media can host, store and/or reproduce computer-executable instructions and data for later retrieval and/or execution. When the computer-executable instructions that are hosted or stored on the computer-readable storage devices are executed, the execution thereof causes, configures and/or adapts the executing computing device to carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer-readable media may deliver the computer-executable instructions (and data) to a computing device for execution via various transmission means and mediums including carrier waves and/or propagated signals, for purposes of this disclosure computer readable media expressly excludes carrier waves and/or propagated signals (i.e., the transmission means of the executable instructions per se.)

Turning now to FIG. 10, FIG. 10 is a block diagram illustrating exemplary components of a suitably configured search engine 430, implemented on a computing device, for responding to a location-activity query, as discussed above. The exemplary search engine 430 includes one or more processors (or processing units), such as processor 1002, and a memory 1004. The processor 1002 and memory 1004, as well as other components, are interconnected by way of a system bus 1010. The memory 1004 typically (but not always) comprises both volatile memory 1006 and non-volatile memory 1008. Volatile memory 1006 retains or stores information so long as the memory is supplied with power. In contrast, non-volatile memory 1008 is capable of storing (or persisting) information even when a power supply is not available. Generally speaking, RAM and CPU cache memory are examples of volatile memory 1006 whereas ROM, solid-state memory devices, memory storage devices, and/or memory cards are examples of non-volatile memory 1008.

Further still, the illustrated search engine 430 includes a network communication component 1012 for interconnecting this computing device with other devices over a computer network, including user computing devices and social networking services. The network communication component 1012, sometimes referred to as a network interface card or NIC, communicates over a network using one or more communication protocols via a physical (e.g., wired, optical, etc.) connection, a wireless connection, or both. As will be readily appreciated by those skilled in the art, a network communication component, such as network communication component 1012, is typically comprised of hardware and/or firmware components (and may also include or comprise software components) that transmit and receive digital and/or analog signals over a transmission medium (i.e., the network.)

The processor 1002 executes instructions retrieved from the memory 1004 (and/or from computer-readable media) in carrying out various functions, particularly in regard to responding to a location-activity search query, as discussed and described above. The processor 1002 may be comprised of any of a number of available processors such as single-processor, multi-processor, single-core units, and multi-core units. While a typical search engine (or other service configured to respond to location-activity search queries) is typically implemented on or across multiple computers or servers operating as a service on a network, elements of the disclosed subject matter maybe implemented on devices such as laptop computers, desktop computers, mini- and mainframe computers, and the like.

The exemplary search engine 430 also includes a check-in data aggregation component 1022. As described above in regard to FIGS. 1 and 2A-2C, the check-in data aggregation component 1022 accesses check-in data from one or more social networking services and aggregates the check-in data according to a location-activity taxonomy 1024 to generate a hierarchical organization of location-activities which are stored in the location-activity data store 1026.

The results page generator 1028 is configured to generate the results of a location-activity query as described above. The results page generator 1028 may be further configured to inter-operate with a search results page generator (not shown) that generates search results pages of typical search results in response to a search query. Alternatively, the results page generator 1028 may be configured with the additional functionality to generate the search results pages of typical search results in response to a search query.

A query analysis component 1030 is configured to perform the analyses of the received search queries to identify the various elements of the search query. This analysis to identify the various elements of the search query is described in greater detail above in regard to FIGS. 1 and 2A-2C. The location-activity identification component 1032 is configured to evaluate the various elements of the search query (as determined by the query analysis component 1030) to determine whether the search query is of the form of a location-activity query, i.e., comprises a specific location (or an implied location) and a requested activity, as well as optional temporal and purpose constraints. Additionally, the location-activity results retrieval component 1034 retrieves location-activity results from the location-activity data store according to a specific location and requested activity, and further according to any optional temporal and/or purpose constraints identified.

While the functionality of responding to a location-activity request is set forth above in regard to an aspect of a search engine, this should be viewed as one embodiment of the disclosed functionality and should not be viewed as limiting upon the disclosed subject matter. In an alternative embodiment, a location-activity recommendation service may be implemented (which may or may not operate cooperatively with a search engine) to provide activity recommendations in regard to a particular location, particularly in regard to a location-activity query as described above.

Regarding the various components of the exemplary search engine 430, those skilled in the art will appreciate that these components may be implemented as executable software modules stored in the memory of the computing device, as hardware modules (including SoCs—system on a chip), or a combination of the two. Moreover, each of the various components may be implemented as an independent, cooperative process or device, operating in conjunction with or on one or more computer systems and or computing devices. It should be further appreciated, of course, that the various components described above in regard to the exemplary search engine 430 should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computer system may be combined together or broke up across multiple actual components and/or implemented as cooperative processes on a computer network.

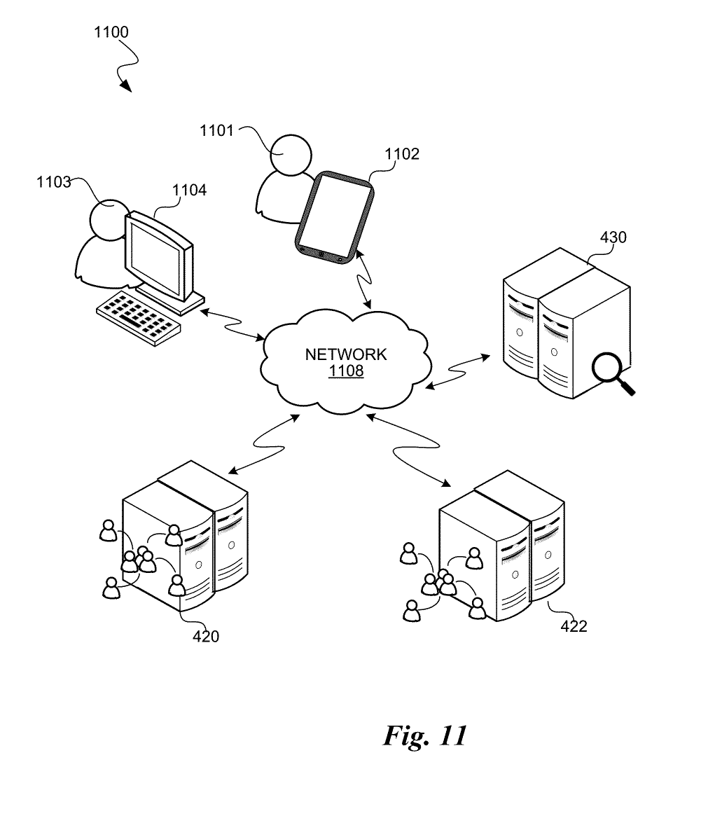

Turning now to FIG. 11, FIG. 11 illustrates an exemplary network environment 1100 suitable for implementing aspects of the disclosed subject matter. The exemplary network environment 1100 includes one or more user computers or computing devices, such as computing devices 1102 and 1104, through which persons/users 1101 and 1103 can submit search queries (including location-activity search queries) to a search engine 430 over a network 1108, and receive responses—including location-activity responses—from the search engine. The network environment 1100 further includes social networking services, such as social networking services 420 and 422 from which the search engine can obtain check-in data.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer system for responding to a search query regarding activities at an indicated location, the system comprising a processor and a memory, and further comprising:
a location-activity data store storing a plurality of location-activity records, each location-activity record comprising information regarding a specific location and an associated activity in the specific location and further comprising a number of check-in records indicating the number of check-ins at the specific location for the associated activity;
wherein the processor executes instructions stored in the memory as part of or in conjunction with additional executable components in response to receiving a query from a computer user, the additional components comprising:
a query analysis component configured to analyze the search query to identify the elements of the query;
a location-activity identification component configured to determine whether the search query is a location-activity query comprising a request regarding desired activities at a desired location;
a location-activity results retrieval component configured to obtain a set of location-activity results from the plurality of location-activity records in the location-activity data store that correspond to the desired activities at the desired location; and
a results page generator configured to generate a results page from the set of location-activity results for presentation to the computer user and return the results page to the computer user in response to the search query.

2. The computer system of claim 1, wherein the location-activity identification component is further configured to determine a constraint associated the location-activity query from the identified elements of the search query.

3. The computer system of claim 2, wherein the constraint comprises a temporal constraint indicating a time frame in which the desired activity is to occur.

4. The computer system of claim 2, wherein the constraint comprises a purpose constraint indicating a purpose for requesting the desired activity.

5. The computer system of claim 2, wherein location-activity data store further stores a plurality of additional information, each item of additional information being associated a location-activity record of the plurality of location activity records, the additional information comprising user feedback regarding the associated activity of the location-activity record at the specific location.

6. The computer system of claim 5, wherein the results page generator places a user-actionable control proximate to a location-activity result of the set of location-activity results in the results page, the user-actionable control configured to present the additional information associated with the location activity result upon user activation.

7. The computer system of claim 2, wherein results page generator generates a results page from the set of location-activity results with the location-activity results ordered according to popularity according to the number of check-ins at the desired location for the associated desired activity.

8. The computer system of claim 7, wherein results page generator generates a results page from the set of location-activity results with the location-activity results ordered according to popularity according to the number of check-ins at the desired location for the associated desired activity, and further according to the determined constraint associated the location-activity query.

9. A computer-implemented method executed on a computing device comprising at least a processor and a memory, the method configured to respond to a search query from a computer user, the method comprising:
providing a location-activity data store storing a plurality of location-activity records, each location-activity record comprising information regarding a specific location and an associated activity in the specific location;
receiving a search query submitted from a computer user over a network; and
determining whether the search query is a location-activity query identifying a desired activity at a desired location and, upon determining that the search query is a location-activity query:
identifying a set of location-activity responses from the location-activity records of the location-activity data store according to the desired location and the desired activity;
generating a response page from the set of location activity responses, the response page identifying a plurality of activities corresponding to the desired activity in the desired location; and
returning the response page for presentation to the computer user over the network.

10. The computer-implemented method of claim 9 further comprising analyzing the search query to identify elements of the search query, and
wherein determining whether the search query is a location-activity query identifying a desired activity at a desired location comprises determining whether the search query is a location-activity query identifying a desired activity at a desired location according to the identified elements of the search query.

11. The computer-implemented method of claim 10 further comprising identifying one or more constraints from the identified elements of the search query, and
wherein identifying the set of location-activity responses from the location-activity records of the location-activity data store according to the desired location and the desired activity comprises identifying the set of location-activity responses from the location-activity records of the location-activity data store according to the desired location and the desired activity and further according to the one or more identified constraints.

12. The computer-implemented method of claim 11, wherein the one or more constraints comprise a temporal constraint indicating a time frame in which the computer user indicates that the desired activity is to occur.

13. The computer-implemented method of claim 11, wherein the one or more constraints comprise a purpose constraint indicating an intended purpose of the computer user regarding the desired activity.

14. The computer-implemented method of claim 11, wherein generating a response page from the set of location activity responses comprises generating a response page from the set of location activity responses, the response page identifying a plurality of activities corresponding to the desired activity in the desired location, and including a user-actionable control for modifying one or more constraints with regard to the desired activity.

15. The computer-implemented method of claim 14 further comprising:
receiving an indication of a user action of the user-actionable control;
determining an updated constraint to be applied to the location-activity query according to the user action of the user-actionable control;
identifying a second set of location-activity responses from the location-activity records of the location-activity data store according to the desired location and the desired activity, and further according to the updated constraint;
generating a second response page from the second set of location activity responses, the second response page identifying a plurality of activities corresponding to the desired activity in the desired location, and the user-actionable control for modifying one or more constraints with regard to the desired activity; and
returning the second response page for presentation to the computer user over the network.

16. The computer-implemented method of claim 11, wherein the plurality of location-activity records are organized in a hierarchical organization according to a location-activity taxonomy.

17. A computer-readable medium bearing computer-executable instructions which, when executed on a computing system comprising at least a processor, carry out a method for responding to a search query from a computer user, the method comprising:
providing a location-activity data store storing a plurality of location-activity records, each location-activity record comprising information regarding a specific location and an associated activity in the specific location;
receiving a search query submitted from a computer user over a network;
analyzing the search query to identify elements of the search query; and
determining whether the search query is a location-activity query identifying a desired activity at a desired location according to the identified elements of the search query and, upon determining that the search query is a location-activity query:
identifying a set of location-activity responses from the plurality of location-activity records of the location-activity data store according to the desired location and the desired activity;
generating a response page from the set of location activity responses, the response page identifying a plurality of activities corresponding to the desired activity in the desired location; and
returning the response page for presentation to the computer user over the network.

18. The computer-readable medium of claim 17, wherein the method further comprises identifying one or more constraints from the identified elements of the search query, and
wherein identifying the set of location-activity responses from the location-activity records of the location-activity data store comprises identifying the set of location-activity responses from the location-activity records of the location-activity data store according to the desired location and the desired activity and further according to the one or more identified constraints.

19. The computer-readable medium of claim 11, wherein the one or more constraints comprise any one or more of a temporal constraint indicating a time frame in which the computer user indicates that the desired activity is to occur, and a purpose constraint indicating an intended purpose of the computer user regarding the desired activity.

20. The computer-readable medium of claim 19, wherein:
generating a response page from the set of location activity responses comprises generating a response page from the set of location activity responses, the response page identifying a plurality of activities corresponding to the desired activity in the desired location, and including a user-actionable control for modifying one or more constraints with regard to the desired activity; and
wherein the method further comprises:
receiving an indication of a user action of the user-actionable control;
determining an updated constraint to be applied to the location-activity query according to the user action of the user-actionable control;
identifying a second set of location-activity responses from the location-activity records of the location-activity data store according to the desired location and the desired activity, and further according to the updated constraint;
generating a second response page from the second set of location activity responses, the second response page identifying a plurality of activities corresponding to the desired activity in the desired location, and the user-actionable control for modifying one or more constraints with regard to the desired activity; and
returning the second response page for presentation to the computer user over the network.
